(19) United States
(12) Patent Application Publication
(10) Pub. No.: US 2026/0204978 A1
(43) Pub. Date: Jul. 16, 2026

(54) Axial Flux Motor for a Motor Vehicle, in Particular for a Car

(71) Applicant: Mercedes-Benz Group AG, Stuttgart (DE)

(72) Inventor: Ralph BURKART, Pfinztal (DE)

(21) Appl. No.: 19/135,672

(22) PCT Filed: Nov. 30, 2023
(86) PCT No.: PCT/EP2023/083840

§ 371 Date: Jun. 4, 2025

(30) Foreign Application Priority Data
Dec. 7, 2022 (DE) 10 2022 004 579.6

(51) Int. Cl. H02K 7/116; H02K 1/02; H02K 16/02

(52) U.S. Cl. CPC H02K 7/116; H02K 1/02; H02K 16/02

(57) ABSTRACT

An axial flux motor for a motor vehicle has a stator and first and second rotors rotatable about a motor axis of rotation relative to the stator. The stator is arranged between the rotors in the axial direction of the axial flux motor. The rotors are at least indirectly non-rotatably connected to each other by respective toothings of the rotors arranged on end faces of the rotors facing each other in the axial direction. The respective toothing is provided on a respective annular surface of the respective end face, the respective toothing is arranged concentrically to the motor axis of rotation, and the rotors and thereby the toothings are braced together in the axial direction by a screw connection bushing which is arranged radially within the rotors and concentrically to the motor axis of rotation and which has a differential thread.

### BACKGROUND AND SUMMARY OF THE INVENTION

The invention relates to an axial flux motor for a motor vehicle, in particular for a car.

Such an axial flux motor for a motor vehicle, in particular for a car, is already known from DE 10 2020 114 855B3 , for example. The axial flux motor has a stator and a first rotor that is rotatable relative to the stator about a motor axis of rotation. The axial flux motor also has a second rotor that can rotate about the motor's axis of rotation relative to the stator. By way of example, the rotors can be driven by means of the stator and can therefore be rotated about the motor's axis of rotation relative to the stator. The stator is arranged between the rotors in the axial direction of the axial flux motor.

The object of the present invention is to improve an axial flux motor of the type mentioned at the beginning.

In order to improve an axial flux motor of the type specified herein, it is provided in accordance with the invention that the rotors are at least indirectly non-rotatably connected to each other by means of respective toothing of the rotors arranged on end faces of the rotors facing each other in the axial direction of the axial flux motor. The respective toothing is provided in or on a respective annular surface of the respective end face. The respective toothing is arranged concentrically to the motor's axis of rotation. The stator can, for example, have a continuous through-opening in which the toothings are arranged, particularly in the axial direction of the electric motor and thus along the motor's axis of rotation. It is also conceivable that the first rotor and the second rotor, in particular a first rotor carrier of the first rotor and a second rotor carrier of the second rotor, are identical in terms of a basic design, i.e., identical in construction and/or mirror-symmetrical. Furthermore, it is conceivable that the rotors differ from each other due to machining and/or due to the toothings and/or due to cooling and/or due to an imbalance compensation and are otherwise preferably designed to be mirror-symmetrical and/or identical, i.e., identical in construction.

In accordance with the invention, it is further provided that the rotors and thus the toothings are braced together in the axial direction of the axial flux motor by means of a screw connection bushing which is arranged radially within the rotors and concentrically to the motor's axis of rotation and which has a differential thread.

In an advantageous embodiment of the invention, it is provided that a first differential threaded part of the differential thread and a second differential threaded part of the differential thread are designed as a fine thread.

In an advantageous embodiment of the invention, it is provided that the first differential threaded part engages with a corresponding third threaded part of the first rotor and the second differential threaded part engages with a corresponding fourth threaded part of the second rotor.

In an advantageous embodiment of the invention, it is provided that the first differential threaded part of the differential thread is in engagement with a corresponding third threaded part of the first rotor and the second differential threaded part is in engagement with a corresponding fourth threaded part of a gear shaft.

In an advantageous embodiment of the invention, it is provided that a locking sleeve is arranged concentrically to the motor's axis of rotation, axially adjacent to the screw connection bushing and on an axially opposite side of the gear shaft, wherein the locking sleeve has a thread with a direction of thread rotation opposite to the differential thread.

In an advantageous embodiment of the invention, it is provided that the rotors are formed from a rotor steel with a high carbon content, wherein the gear shaft is formed from a chromium-molybdenum steel.

In an advantageous embodiment of the invention, it is provided that the gear shaft is connected to one of the rotors via two further toothings in engagement with each other.

In an advantageous embodiment of the invention, it is provided that an intermediate shaft made of chromium-molybdenum steel is provided between the two rotors.

In an advantageous embodiment of the invention, it is provided that the toothings are designed as Hirth toothings.

The aforementioned chromium and molybdenum steel is also referred to as Cr-Mo steel. In particular, the aforementioned rotor steel is more cost-intensive than the Cr-Mo steel, in particular the unit of weight, such that the Cr-Mo steel is more cost-effective than the rotor steel. The background to this can be in particular that a laminate is provided for a rotor magnetic field, which is formed, for example, by a coiled, thin and narrow sheet metal strip or comprises a coiled, thin and narrow sheet metal strip, wherein the laminate or the sheet metal strip can be arranged as a layer adjacent to permanent magnets of the axial flux motor. By way of example, the laminate is soldered to the rotor steel.

Overall, it can be seen that the rotors, also referred to as rotor halves or rotor elements, or formed as rotor halves or rotor elements, preferably clamp the axial flux motor together in the axial direction of the electrical motor by means of the in particular internal screw connection bushing, which is preferably formed as threaded bushing, and by means of the differential thread, i.e., are in particular braced against each other, whereby in particular the toothings, preferably designed as Hirth toothings, are clamped together in the axial direction of the axial flux motor, i.e., braced against each other, in particular at least indirectly or directly.

In particular, at least the following advantages can be realized by means of the invention:
easier assembly compared to conventional solutions,
less machining of the rotors compared to conventional solutions,
both rotors can be at least almost identical and thus designed as identical parts, which means that the manufacturing efforts can be kept particularly low,
lower imbalance compared to conventional solutions,
symmetry of the rotors, which leads to the same vibration behaviour of both rotor halves, thus eliminating the need to tune the distinct axial frequencies,
fewer components,
there is no need for a welded connection for the respective rotor, which means there is no heat distortion and less imbalance, which leads to better noise behaviour, also known as NVH behaviour,
there is no need for a welded connection to the gear shaft,
there is no need to seal the toothings.

Further advantages, features and details of the invention emerge from the following description of preferred exemplary embodiments and from the drawings. The features and combinations of features mentioned above in the description as well as the features and combinations of features mentioned below in the description of the figures and/or shown in the figures alone can be used not only in the combination specified in each case, but also in other combinations or on their own without departing from the scope of the invention.

### BRIEF DESCRIPTION OF THE DRAWINGS

FIG. 1, in section, is a schematic longitudinal sectional view of a first embodiment of an axial flux motor for a motor vehicle, in particular for a car;

FIG. 2, in section, is a schematic longitudinal sectional view of a second embodiment of the axial flux motor;

FIG. 3, in section, is a schematic longitudinal sectional view of a third embodiment of the axial flux motor; and

FIG. 4, in section, is a schematic longitudinal sectional view of a fourth embodiment of the axial flux motor.

### DETAILED DESCRIPTION OF THE DRAWINGS

In the figures, identical or functionally identical elements are provided with the same reference numerals.

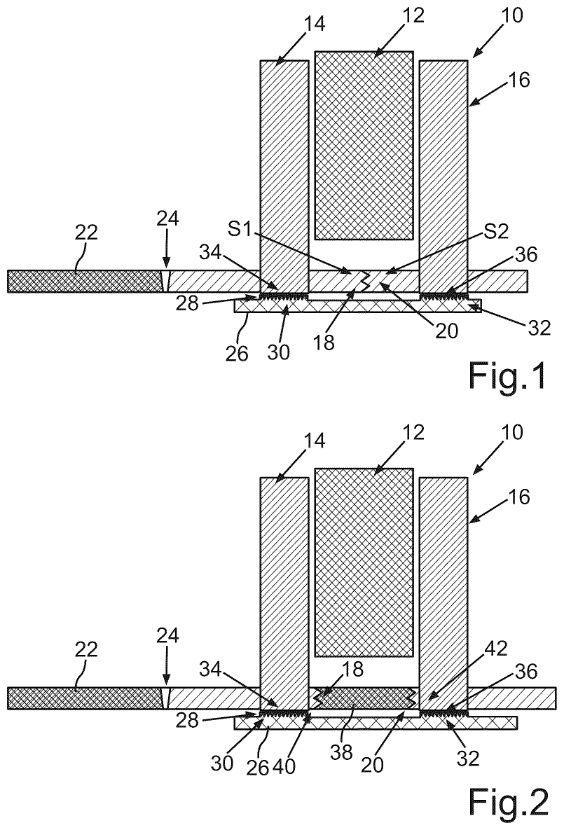

FIG. 1 shows, in sections, a schematic longitudinal sectional view of a first embodiment of an axial flux motor 10 for a motor vehicle, in particular for a car. The axial flux motor 10 has a stator 12, a first rotor 14 and a second rotor 16, wherein the rotors 14 and 16 are rotatable about a common motor axis of rotation relative to the stator 12. In particular, the rotors 14 and 16 can be driven by means of the stator 12 and thereby rotated about the motor's axis of rotation relative to the stator 12. It can be seen from FIG. 1 that the stator 12 is arranged at least partially between the rotors 14 and 16, which are also referred to as rotor halves or rotor elements, when viewed in the axial direction of the axial flux motor 10 and thus along the motor's axis of rotation. The axial flux motor 10 is an electric motor designed as an axial flux motor.

In order to be able to manufacture the axial flux motor 10 in a particularly simple and thus particularly time- and cost-effective manner, it is provided in the axial flux motor 10 that the rotors 14 and 16 are at least indirectly non-rotatably connected to each other by means of respective toothings 18 and 20 of the rotors 14 and 16, which are arranged on end faces S1 and S2 of the rotors 14 and 16 facing one another in the axial direction of the axial flux motor 10. In the first embodiment shown in FIG. 1, the toothings 18 and 20 engage directly with one another, such that in the first embodiment it is provided that the rotors 14 and 16 are directly non-rotatably connected to one another by means of the toothings 18 and 20. The respective toothings 18, 20 are provided on a respective annular surface of the respective end face S1, S2. In addition, the respective toothing 18, 20 is arranged concentrically to the motor's axis of rotation.

A gear shaft 22 can also be seen in FIG. 1. The gear shaft 22 is formed separately from the rotors 14 and 16 and is non-rotatably connected to the rotor 14, such that the gear shaft 22 is also non-rotatably connected to the rotor 16 via the rotor 14. In the present case, the gear shaft is connected to the rotor 14 by means of a welded connection 24, i.e., welded, whereby the gear shaft 22 is non-rotatably connected to the rotor 14. The respective rotor 14, 16 is formed, for example, from a first steel, wherein the first steel is also referred to as a rotor steel. The first steel is, for example, EN 24T. The gear shaft 22 is formed, for example, from a second steel which is different from the first steel, wherein the second steel is preferably a Cr-Mo steel. In particular, the second steel can be 20MoCr4.

In the first embodiment, the rotors 14 and 16 and thereby the toothings 18 and 20 are braced together in the axial direction of the axial flux motor 10 by means of a screw connection bushing 26, which is arranged radially, i.e., in the radial direction of the axial flux motor 10, within the rotors 14 and 16 and is arranged or extends or formed concentrically with respect to the motor's axis of rotation and is also referred to as a threaded bushing. By way of example, the screw connection bushing 26 is formed from the second steel. The screw connection bushing 26 is formed separately from the rotors 14 and 16 and separately from the gear shaft 22. In the first embodiment, the gear shaft 22 is a shaft of a planetary gear set. The planetary gear set has, for example, a sun gear which is non-rotatably connected to the gear shaft 22. The gear shaft 22 is therefore a sun shaft.

It can be seen from FIG. 1 that the screw connection bushing 26 has a differential thread 28 with a first differential threaded part 30 and a second differential threaded part 32. By way of example, the differential threaded parts 30 and 32 are designed as fine threads. The first differential threaded part 30 has a first thread pitch, also referred to as the first pitch, and the second differential threaded part 32, which is also referred to simply as the second threaded part, has a second thread pitch different from the first thread pitch, which is also referred to simply as the second pitch. By way of example, the second thread pitch differs from the first thread pitch by at most 10%, in particular of the first thread pitch, or vice versa.

In the first embodiment, the first differential threaded part 30 is in engagement, in particular directly, with a corresponding third threaded part 34 of the first rotor 14, wherein the second differential threaded part 32 is in engagement, in particular directly, with a corresponding fourth threaded part 36 of the rotor 16. This means that the differential threaded part 30 is screwed, in particular directly, to the threaded part 34, and the differential threaded part 32 is screwed, in particular directly, to the threaded part 36.

FIG. 2 shows, in sections, a schematic longitudinal sectional view of a second embodiment of the axial flux motor 10. The second embodiment differs in particular from the first embodiment in that, while in the first embodiment the toothings 18 and 20 engage directly with each other, i.e., are in direct engagement with each other, in the second embodiment the toothings 18 and 20 do not engage directly with each other. Thus, in the second embodiment it is provided that the rotors 14 and 16 are indirectly non-rotatably connected to each other by means of the toothings 18 and 20. In the second embodiment, a spacer ring 38 is provided, which is arranged between the toothings 18 and 20 in the axial direction of the axial flux motor 10. In particular, the spacer ring 38 is formed from the second steel. The spacer ring 38 has a third toothing 40 corresponding to the toothing 18, which engages directly in the toothing 18 and is therefore in direct engagement with the toothing 18. In addition, the spacer ring 38 has a fourth toothing 42 corresponding to the second toothing 20, which engages directly in the toothing 20 and is therefore in direct engagement with the toothing 20. Thus, in the second embodiment, the rotors 14 and 16 are non-rotatably connected to each other by means of the toothing 18, 20, 40 and 42 and indirectly. By way of example, the toothings 18 and 20 are designed as Hirth toothings, such that the toothings 40 and 42 are preferably also designed as Hirth toothings.

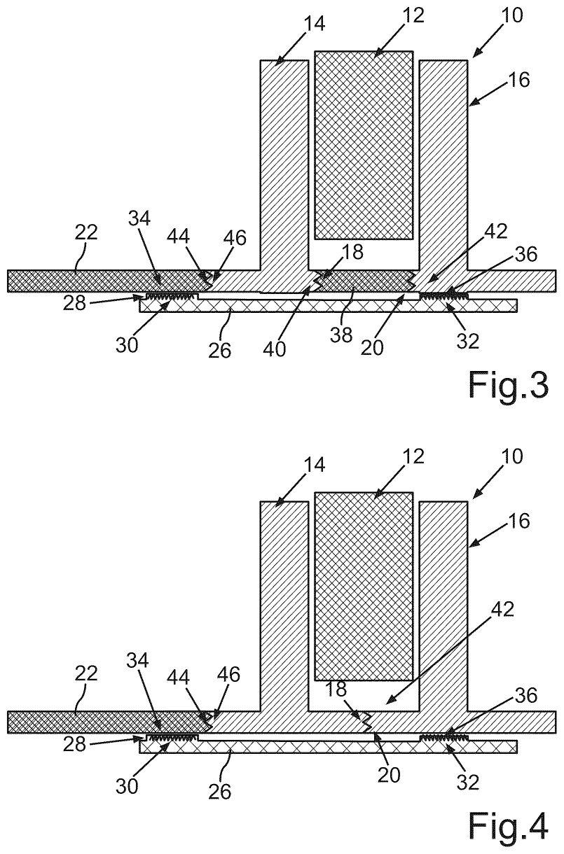

FIG. 3 shows, in sections, a schematic longitudinal sectional view of a third embodiment of the axial flux motor 10. The third embodiment differs in particular from the second embodiment in that the third threaded part 34 corresponding to the differential threaded part 30 is not a threaded part of the rotor 14, but a threaded part of the gear shaft 22 and is thus provided on the gear shaft 22.

Finally, FIG. 4 shows, in sections, a schematic longitudinal sectional view of a fourth embodiment of the axial flux motor 10. The fourth embodiment differs in particular from the third embodiment in that, while in the third embodiment the spacer ring 38 is provided as in the second embodiment, in the fourth embodiment the spacer ring 38 is omitted. Thus, in the fourth embodiment, the rotors 14 and 16 are directly non-rotatably connected to each other by means of the toothings 18 and 20, in that in the fourth embodiment the toothings 18 and 20 engage directly with each other.

It can be seen from FIGS. 1 to 4 that the stator 12 has a through opening 45, which is continuous in the axial direction of the axial flux motor 10. At least in the first embodiment and in the fourth embodiment, the toothings 18 and 20 are arranged in the through opening 45, in particular in such a way that the toothings 18 and 20 are overlapped by the stator 12 when viewed from the outside in the radial direction of the axial flux motor 10, and are therefore covered. In the second embodiment and the third embodiment, it is also conceivable that the respective toothing 18, 20 is arranged at least partially in the through opening 45 of the stator 12.

The third embodiment and the fourth embodiment also differ in particular from the first embodiment and from the second embodiment in that the gear shaft 22 is non-rotatably connected to the rotor 14 by means of further toothings 44 and 46. The toothings 44 and 46 are arranged on the end faces of the gear shaft 22 and the rotor 14 that face each other in the axial direction of the axial flux motor 10, wherein in the present case the toothings 44 and 46 of the gear shaft 22 and the rotor 14, which are designed here as Hirth toothings, for example, engage directly with each other. By way of example, the toothing 18 is arranged on the end face S1 as the first end face of the rotor 14, wherein, for example, the toothing 46 of the rotor 14 is arranged on a third end face of the rotor 14, the third end face of which points away from the first end face S1, for example in the axial direction of the axial flux motor 10, and is therefore facing away. The end face of the gear shaft 22, on the end face of which the toothing 42 is arranged, is also referred to as the fourth end face, for example, which faces the third end face in the axial direction of the axial flux motor 10.

### LIST OF REFERENCE CHARACTERS

10 axial flux motor
12 stator
14 first rotor
16 second rotor
18 toothing
20 toothing
22 gear shaft
24 welded connection
26 screw connection bushing
28 differential thread
30 first threaded part
32 second threaded part
34 third threaded part
36 fourth threaded part
38 spacer ring
40 toothing
42 toothing
44 toothing
45 through opening
46 toothing

1.-9. (canceled)

10. An axial flux motor (10) for a motor vehicle, comprising:
a stator (12);
a first rotor (14) rotatable about a motor axis of rotation relative to the stator (12);
a second rotor (16) rotatable about the motor axis of rotation relative to the stator (12); and
a screw connection bushing (26), wherein the screw connection bushing (26) has a differential thread (28);
wherein the stator (12) is disposed between the first rotor (14) and the second rotor (16) in an axial direction of the axial flux motor (10);
wherein the first rotor (14) has a first toothing (18) disposed on a first end face (S1) of the first rotor (14) and the second rotor (16) has a second toothing (20) disposed on a second end face (S2) of the second rotor (16), wherein the first end face (S1) and the second end face (S2) face each other in the axial direction of the axial flux motor (10), and wherein the first rotor (14) and the second rotor (16) are at least indirectly non-rotatably connected to each other by the first toothing (18) and the second toothing (20);
wherein the first toothing (18) is disposed on a first annular surface of the first end face (S1) and wherein the second toothing (20) is disposed on a second annular surface of the second end face (S2);
wherein the first toothing (18) and the second toothing (20) are disposed concentrically to the motor axis of rotation;
wherein the first rotor (14) and the second rotor (16) are braced together in the axial direction of the axial flux motor (10) by the screw connection bushing (26) which is disposed radially within the first rotor and the second rotor (16) and concentrically to the motor axis of rotation.

11. The axial flux motor (10) according to claim 10, wherein a first differential threaded part (30) of the differential thread (28) and a second differential threaded part (32) of the differential thread (28) are each a fine thread.

12. The axial flux motor (10) according to claim 11, wherein the first differential threaded part (30) engages with a first threaded part (34) of the first rotor (14) and the second differential threaded part (32) engages with a second threaded part (36) of the second rotor (16).

13. The axial flux motor (10) according to claim 11, wherein the first differential threaded part (30) engages with a first threaded part (34) of a gear shaft (22) and the second differential threaded part (32) engages with a second threaded part (36) of the second rotor (16).

14. The axial flux motor (10) according to claim 13, wherein a locking sleeve is disposed concentrically to the motor axis of rotation, axially adjacent to the screw connection bushing (26)) and on an axially opposite side of the gear shaft (22), and wherein the locking sleeve has a thread with a direction of thread rotation opposite to the differential thread (28).

15. The axial flux motor (10) according to claim 13, wherein the first rotor (14) and the second rotor (16) are formed from a rotor steel with a high carbon content and wherein the gear shaft (22) is formed from a chromium-molybdenum steel.

16. The axial flux motor (10) according to claim 13, wherein the gear shaft (22) is connected to the first rotor (14) via respective toothings 46) in engagement with each other.

17. The axial flux motor (10) according to claim 10, wherein an intermediate shaft (38) made of chromium-molybdenum steel is disposed between the first rotor (14) and the second rotor (16).

18. The axial flux motor (10) according to claim 10, wherein the first toothing (18) and the second toothing (20) are each a Hirth toothing.
